(19) United States
(12) Patent Application Publication
(10) Pub. No.: US 2005/0176405 A1
(43) Pub. Date: Aug. 11, 2005

(54) Train network access service management method and communication system employing this method, and service management system therefor

(75) Inventor: Keiji Maeda, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/049,105

(22) Filed: Feb. 3, 2005

(30) Foreign Application Priority Data
Feb. 5, 2004 (JP) 2004-028737

(51) Int. Cl. H04M 11/00

(52) U.S. Cl. 455/406

(57) ABSTRACT

According to the present invention, a service management system has a function for issuing an ID and a password effective for a date, for a train and for an interval designated by each service user; a function for authenticating the ID and the password, and starting the provision of service for the passenger; and a function for halting the service when the ID and the password have expired; a function for collecting, for example, an operating schedule from an operating information management system owned by a railroad company; a function for collecting, from a train connection device, network use records (communication quantities) before the provision of a service for the passenger is started; a function for paying a fee based on the network use record; and a function for requesting that the fee collection system collect the service charge, and for receiving the service charge.

### BACKGROUND OF THE INVENTION

1. Field of the Invention

The present invention relates to a train network access service management method and a communication system employing this method, and a service management system therefor. Particularly, the present invention relates to a service charge collection method for a passenger on a train who employs multiple wireless access lines to access a network.

2. Related Background Art

Conventionally, while in transit by train, a passenger desiring to access the Internet must first connect to a specific wireless network, and to do this, must employ individually available means, such as a PHS (Personal Handyphone System) or a cellular phone. However, while a train is passing through a specific area, a tunnel, for example, radio wave transmission/reception may be inhibited, and an ongoing connection, with a wireless network outside the area, broken. In this case, communication between locations inside and outside the train is disabled, and a suitable connection environment can not be established when an Internet connection service is employed that depends on only one wireless network. As means for resolving this problem, systems are available that establish seamless connections by using (1) a train radio service prepared at the expense of a railroad company (see JP-A-2002-344478 (hereinafter referred to as patent document 1)), and (2) a system for switching between various radio networks (a train radio, a railroad station based wireless LAN (Local Area Network) and a cellular phone) (see JP-A-2002-111702 (hereinafter referred to as patent document 2)).

Furthermore, a system for employing multiple network lines to provide a network access service for train passengers is described in patent document 2, mentioned above, and JP-A-2001-222603 (hereinafter referred to as patent document 3). In patent document 3, a railroad company employs broadcast satellite communication or ground wave communication to provide Internet connection services, such as a connection to a Web site from a train in transit and the transmission and reception of email.

Further, means for providing a service for train passengers using a single network is described in patent document 1, mentioned above. In patent document 1, the issue of an ID (Identification) and a password, and the exchange of service charge information are described while referring to FIG. 2.

However, when, as described in the technique for patent document 2, a service provider provides an Internet connection environment as an Internet connection service for train passengers by employing multiple wireless networks, many complicated procedures, such as concluding a contract with a passenger (e.g., issuing an ID and a password, and collecting a service charge), the payment of a network fee to a communication common carrier or an ISP (Internet Service Provider), and the payment of a price (e.g., a space use fee for an installed device, and a business permission fee) to a railroad company for providing a communication service in trains. Therefore, an improvement in the efficiency is required.

In addition, since a network access service is provided only in a limited space, i.e., only within a train, and only during a limited period of time, the service fee paid by a passenger must be flexibly designated in accordance with an onboard distance and an onboard period of time. Moreover, when the operation of a train is adversely affected by a disaster or an accident, the use time must be changed in accordance with the actual operating schedule.

According to the technique disclosed in patent document 3, it is not assumed that a railroad company will collect a service charge from a passenger while serving as a provider. Also, the expense (network use fee) of a broadcast satellite communication network and a ground wave network, which are communication means, is not taken into account.

According to patent document 2, not only is a train wireless system owned by a railroad company proposed, but means is also proposed for resolving technical problems that arise when a seamless connection environment is provided on a moving train by employing a wireless network, such as a station wireless LAN, owned by a communication common carrier, or a cellular phone. However, means for resolving problems that are encountered when a pay service is provided for passengers is not described.

In other words, while a problem resolving method is presented for the technical problems encountered when a service involving the use of multiple wireless networks is provided for passengers on a train, no means is presented for the resolution of contract problems between a service user, a passenger, and a provider, and the transfer of money between them.

Furthermore, in patent document 1, a specific method is not described that provides for an advance application for a service. In addition, since a train passenger receives the service only during the onboard interval, an operation that is limited in time and in distance is required in order to prevent the misappropriation of an ID and a password entered by a passenger. Further, since conditions governing the operation of a train can be changed to account for weather conditions and obstacles, the operation of the service must also cope with alterations in the operating schedule.

### SUMMARY OF THE INVENTION

It is, therefore, one objective of the present invention to provide a train network access service management method, whereby connections with multiple network providers are established and an Internet connection service is stably provided and whereby the transfer of money consonant with use is performed; a communication system that employs this method; and a service management system.

To achieve this objective, according to one aspect of the present invention, a train network access service management method, for managing multiple network access services on a train, comprises the step of: multiple communication common carriers that own different data communication networks, a network access service provider that connects the different data communication networks to other networks, a railroad company that owns the train or another company, collecting service charges collectively from service users through the other networks.

According to another aspect of the present invention, a communication system for managing multiple network access services on a train comprises:

a unit for permitting multiple communication common carriers that own different data communication networks, a network access service provider that connects the different data communication networks to other networks, a railroad company that owns the train, or another company, to collect service charges from service users collectively through the other networks.

According to an additional aspect of the present invention, a service management system for managing multiple network access services on a train comprises:

a unit to serve as a proxy for multiple communication common carriers, which own different data communication networks, a network access service provider, which connects the different data communication networks to other networks, a railroad company, which owns the train, or another company to collect service charges from service users collectively through the other networks.

According to the present invention, money consonant with the service use record is transferred via a network.

As the first effects obtained by the invention, when the service management system of the invention is employed, a service provider can unite various data communication networks and stably provide a connection service on trains. This is because not only a technique for connecting a bundle of multiple lines is employed, but also the complicated transfer of money between the individual service users and multiple communication common carriers, the issuing of an ID and a password, and the collection of these charges can be easily performed.

As the second effect obtained by the invention, a network access service for a limited space and time, as on trains, can be provided. This is because means for determining the start and the end for the provision of the service examines the operating record for a train.

### BRIEF DESCRIPTION OF THE DRAWINGS

FIG. 1 is a diagram showing an example configuration for a communication system that employs a train network access service management method according to a first embodiment of the present invention;

FIG. 2 is a diagram showing an example seamless connection and an example multiplex connection established by the communication system according to the embodiment;

FIG. 3 is a diagram showing an example of the information exchange and money transfer activities of a service management company and other companies in the communication system of the embodiment;

FIG. 4 is a diagram showing an example configuration for the service management system according to the embodiment;

FIG. 5 is a diagram showing an example structure for ID/password information;

FIG. 6 is a diagram showing an example structure for an operating schedule;

FIG. 7 is a diagram showing an example structure for an operating record;

FIG. 8 is a diagram showing an example structure for communication quantity information;

FIG. 9 is a diagram showing an example structure for aggregated charge information;

FIG. 10 is a diagram showing an example structure for a service fee table;

FIG. 11 is a diagram showing an example structure for a paid fee table;

FIG. 12 is a diagram for explaining an example onboard interval for a user;

FIG. 13 is a diagram showing an example structure for a use condition input screen;

FIG. 14 is a flowchart showing an example operation performed by an ID/password issuing unit until an ID and a password have been issued;

FIG. 15 is a flowchart showing an example operation from the start of the provision of a service for a user until the provision of the service is ended;

FIG. 16 is a flowchart showing an example “money transfer” operation according to the first embodiment;

FIG. 17 is a diagram showing the configuration of a communication system according to a third embodiment of the present invention;

FIG. 18 is a flowchart showing an example operation performed by an ID/password issuing unit of the third embodiment until an ID and a password have been issued.

### DETAILED DESCRIPTION OF THE PREFERRED EMBODIMENTS

The preferred embodiments of the present invention will now be described while referring to the accompanying drawings.

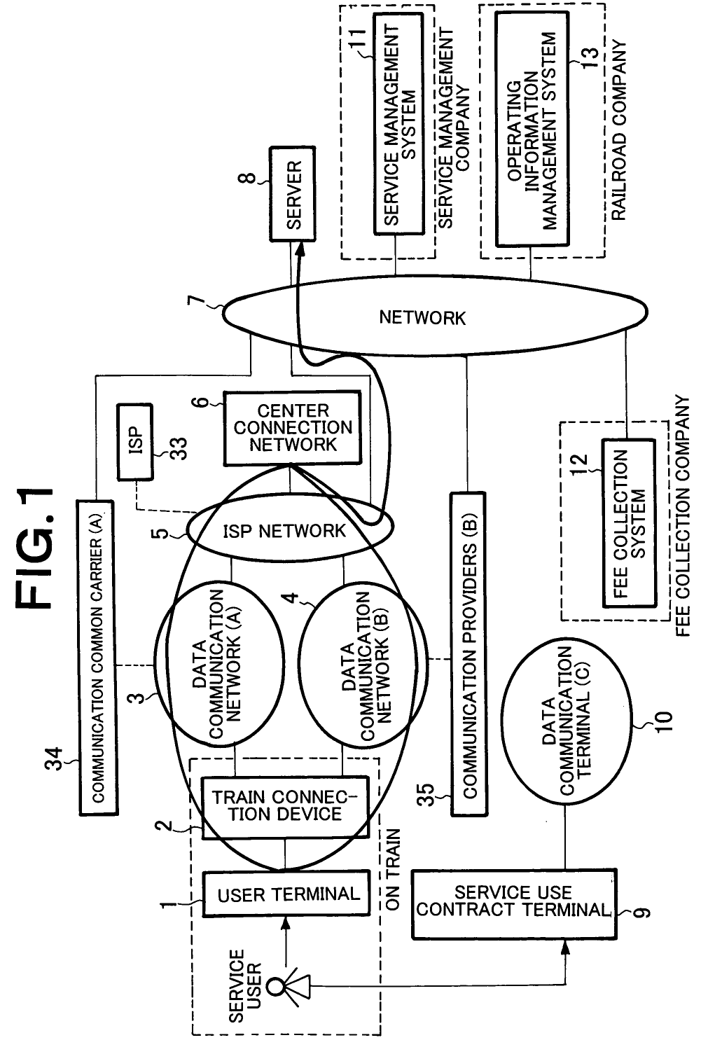

To begin, a first embodiment will be explained. FIG. 1 is a diagram showing an example configuration for a communication system that employs a train network access service management method according to the present invention. In FIG. 1, this communication system comprises: a user terminal 1, a train connection device 2, a data communication network (A) 3, a data communication network (B) 4, an ISP network 5, a center connection device 6, a network 7, a server 8, a service use contact terminal 9, a data communication network (C) 10, a service management system 11, a fee collection system 12, an operating information management system 13, a communication common carrier (A) 34, a communication common carrier (b) 35 and an ISP 33.

The user terminal 1 is an information terminal, such as a notebook computer, carried by a passenger, and is connected to the train connection device 2 through a wireless LAN. As is indicated by an arrow in FIG. 1, data output by the user terminal 1 are transmitted by the train connection device 2 through the data communication network (A) 3, or the data communication network (B) 4, and the ISP network 5 to the center connection device 6, and then are again transmitted through the ISP network 5 and the network 7 to the server 8, such as a Web server or an email server.

The train connection device 2 is installed so as to form a set with the center connection device 6, and is a communication device having a function for the relaying of data received from the user terminal 1 to either one of, or both, the data communication network (A) 3 and the data communication network (B) 4, and a function for the transmission to the user terminal 1 of data received along the data communication network (A) 3 or the data communication network (B) 4. The train connection device 2 also has a function for measuring and storing a communication quantity, such as the number of packets or the number of bytes, for each data communication network that is employed, and information relative to the communication quantity can be read from the service management system 11. The train connection device 2 is owned by a railroad company; however, this device 2 may be owned, for example, by a service management company, and may be installed in space that is rented from the railroad company.

The data communication network (A) 3 and the data communication network (B) 4 are data communication networks for mobile members, such as cellular phones or PHSes, owned by communication common carriers, or data communication networks owned by communication common carriers that provide a network access service at stations using a wireless LAN.

The ISP network 5 is a communication network owned by the ISP 33 and provides an intermediate connection from the data communication network (A) 3 and the data communication network (B) 4 to the network 7.

The center connection device 6 is installed so as to form a set with the train connection device 2, and is a communication device that has a function for relaying, through the ISP network 5 to one of, or both, the data communication network (A) 3 and the data communication network (B) 4, data transmitted through the network 7 to the user terminal 1, and a function for collectively transmitting, through the ISP network 5 to the network 7, data received from the data communication network () 3 or the data communication network (B) 4.

The network 7 is an open network employing the IP (Internet Protocol), and is connected to the server 8, such a Web server, an email server or a contents server that is generally disclosed.

The server 8 is a server, such as a Web server, an email server or a contents server, that is consonant with an application employed by the user terminal.

The service use contract terminal 9 is an information terminal, such as a user owned cellular phone, used to establish a contract that enables the user to receive a network access service on a train. The service use contract terminal 9 transmits a date for the provision of the service on a train, a train number and an onboard interval, which have been entered, and receives an ID and a password that are effective only under contracted conditions and that are issued by the service management system 11. At this time, the service use contract terminal 9 transmits, for example, credit card information to the fee collection system 12 to pay a service fee.

The service use contract terminal 9 is used on a train to make a contract with a network access service. However, since it is also assumed that a contract will be made before boarding a train, in the example in FIG. 1, the service use contract terminal 9 is shown outside a train. The service use contract terminal 9 may be also be shown inside the train.

The data communication network (C) 10 is a network for connecting the service use contract terminal 9 and the service management system 11. When the service use contract terminal 9 is a cellular phone, the data communication network owned by the cellular phone company corresponds to the data communication network (C) 10.

The service management system 11 is a system that provides a network access service for a service user, and has a function for the issuing of an ID and a password that can be used on a date, on a train and during an onboard interval that are designated by the service user, a function for authenticating an ID and a password and starting a service for a passenger, and a function for halting the provision of the service when the ID and the password are expired.

The service management system 11 also has a function for collecting the operating schedule and the current operating record from the operating information management system 13 of the railroad company in order to understand the operating condition of a train. The service management system 11 further includes: a function for collecting, from the train connection device 2, a use record (communication quantity) for the networks (the data communication network (A) 3, the data communication network (B) 4 and the ISP network 5) that are employed to provide a service for passengers; a function for paying a fee based on the use record; and a function for charging a fee collected by the fee collection system 12 and receiving the money therefrom.

The fee collection system 12 includes: a function for confirming a service user based on the credit card information that is entered by the passenger using the service use contract terminal 9, and for collecting a use fee; and a function for paying the charge requested by the service management system 11.

The operating information management system 13 is a system owned by a provider, such as a railroad company, that manages train operations. The operating information management system 13 stores operating information that includes the operating schedule and the current operating record, and has a function for providing the operating information to the service management system 11.

The communication common carrier (A) 34 is a provider that owns the data communication network (A) 3, and the communication common carrier (B) 35 is a provider that owns the data communication network (B) 4.

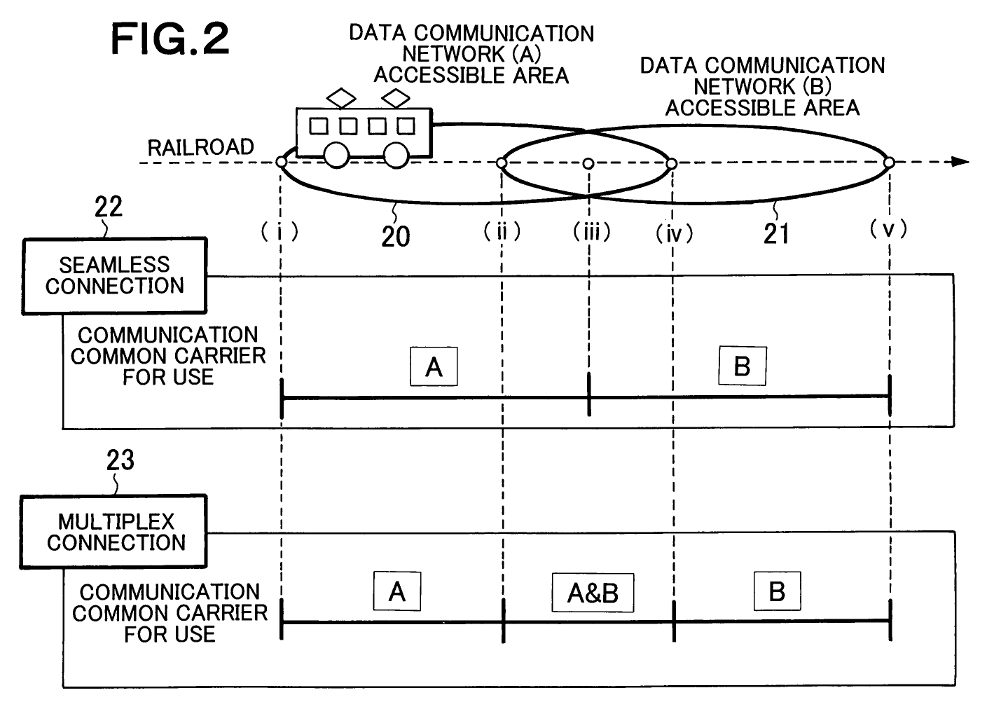

While referring to FIG. 2, two modes (a seamless connection method 22 and a multiplex connection method 23) that employ the data communication network A (3) and the data communication network (B) 4 in FIG. 1 will now be described by using an example wherein an area 20, accessible to the data communication network (A) 3, and an area 21, accessible to the data communication network (B) 4, are partially overlapped. FIG. 2 is a diagram showing an example seamless connection and an example multiplex connection in the data communication networks for the communication system according to the present invention.

The seamless connection method 22 is a method whereby the connection is continuously established throughout the entire interval, and only one network is employed at one time. That is, the data communication network (A) 3 is employed for the interval between (i) and (iii), and the data communication network (B) 4 is employed for the interval between (iii) to (v).

The multiplex connection method 23 is a method whereby the two data communication networks are multiplexed for the interval wherein the networks are overlapped, and whereby the connection is continuously established for the other intervals at the switching points.

According to the multiplex connection method 23, the data communication network (A) 3 is employed for the interval between (i) and (iii), and the data communication networks (A) 3 and (B) 4 are multiplexed and employed for the interval between (ii) to (iv). Compared with the seamless connection method 22, the multiplex connection method 23 has a feature that permits a plurality of networks to be multiplexed.

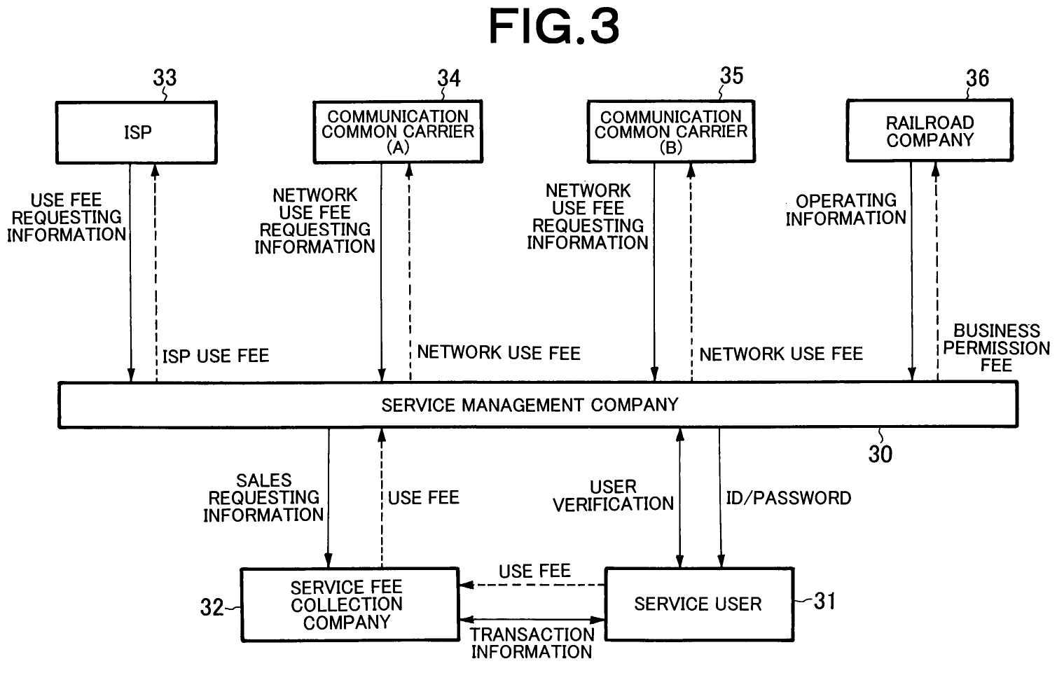

While referring to FIG. 3, an explanation will be given for the operation wherein the communication system of the invention is employed to exchange information and to transfer money between a service management company that provides a service, and the other providers and a service user. FIG. 3 is a diagram showing the operation wherein the communication system of the invention is employed to exchange information and to transfer money between a service management company and other companies.

In FIG. 3, there are shown a service management company 30, a service user 31, a service fee collection company 32, an ISP 33, a communication common carrier (A) 34, a communication common carrier (B) 35 and a railroad company 36.

Means connected through a computer network with a bank (not shown) is employed for the transfer of money, and the data communication network (C) 10 or the network 7 in FIG. 1 is employed for the exchange of information relative to the money.

The service management company 30 is a provider that provides a network access service on a train for the service user 31, and owns the service management system 11 in FIG. 1.

The service user 31 is a passenger who utilizes the network access service on the train, and who has the user terminal 1 and the service use contract terminal 9 in FIG. 1. The service user 31 employs the user terminal 1 in FIG. 1 to enter an ID and a password that are issued and transmitted by the service management company 30, and after the ID and the password have been authenticated, can employ the service. Further, the service user 31 transmits transaction information, such as credit card information, to the service fee collection company 32, and after having been authenticated, pays a service charge.

The service fee collection company 32 employs the fee collection system 12 in FIG. 1 to collect a service fee via an electronic transaction by using a credit card number that is transmitted by the service user 31 via the network 7. Thereafter, upon receiving a payment request from the service management company 30, the service fee collection company 32 pays the service fee.

The ISP 33, which has the ISP network 5 in FIG. 1, requests of the service management company 30 a use fee for the ISP network 5, and receives the fee.

The communication common carrier (A) 34, which owns the data communication network (A) 3 in FIG. 1, requests of the service management company 30 a network use fee in accordance with the network use record, and receives the fee. Similarly, the communication common carrier (B) 35, which owns the data communication network (B) 4, requests of the service management company 30 a network use fee in accordance with the network use record, and receives the fee.

The railroad company 36, which is a company that operates trains, owns the operating information management system 13 in FIG. 1, and provides, for the service management company 30, such operating information as an operating schedule and the current operating condition. The railroad company 36 receives, from the service management company 30, a price (e.g., a business permission fee or a space rental fee) for renting space used to provide the network access service on a train (e.g., a space for the installation of a business machine or device).

The service management company 30 employs the network 7 to exchange information or transfer a use fee relative to the ISP 33, the communication common carrier (A) 34, the communication common carrier (B) 35, the railroad company 36 and the service fee collection company 32. The network 7 and the data communication network (C) 10 are employed for the exchange of information by the service management company 30 and the service user 31. The network 7 and the data communication network (C) 10 are also used for the exchange of information by the service fee collection company 32 and the service user 31.

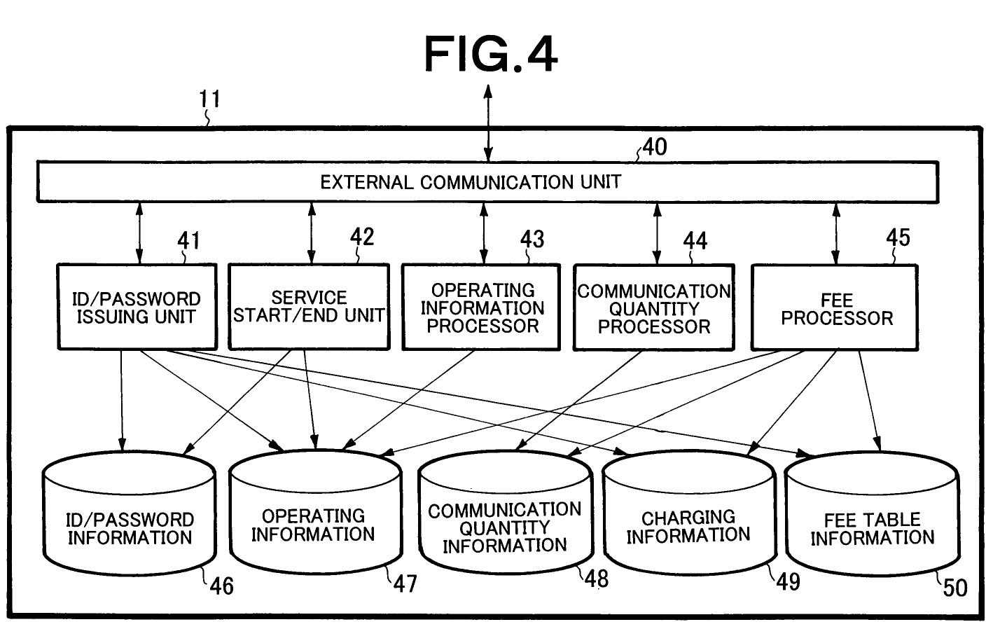

A detailed configuration for the service management system 11 of the invention will now be described while referring to FIG. 4. FIG. 4 is a diagram showing an example configuration for the service management system 11 according to the invention.

In FIG. 4, the service management system 11 comprises an external communication unit 40, an ID/password issuing unit 41, a service start/end unit 42, an operating information processor 43, a communication quantity processor 44 and a fee processor 45, and includes five types of information: ID/password information 46, operating information 47, communication fee information 48, charging information 49 and fee table information 50.

The external communication unit 40 is means for communicating via the network 7 in FIG. 1 with the fee collection system 12, the operating information management system 13, the service use contract terminal 9, the train connection device 2, the communication common carrier (A) 34 and (B) 35 and the ISP 33. The external communication unit 40 has a function for the exchange of information with the ID/password issuing unit 41, the service start/end unit 42, the operating information processor 43, the communication quantity processor 44 and the fee processor 45.

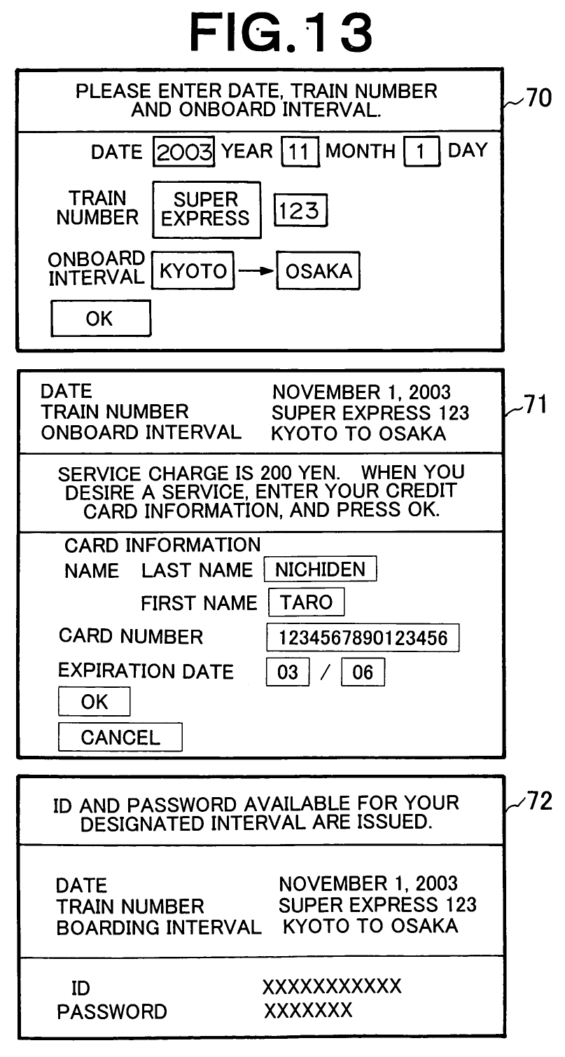

The ID/password issuing unit 41 has a function for the issue of an ID and a password that are effective only under the conditions (a date, a train and an interval) that the service user 31 enters using the service use contract terminal 9 in FIG. 1. The ID/password issuing unit 41 has a function for generating and transmitting, to the service use contract terminal 9, data that are to be displayed on ID/password issuing screens 70 to 72 shown in FIG. 13, which will be described later.

For the generation of data to be transmitted, the ID/password issuing unit 41 also has a function for extracting, from the fee table information 50, service fee information consonant with the conditions entered by the service user 31. Further, the ID/password issuing unit 41 has a function for examining the operating schedule of the operating information 47 to determine whether the conditions entered by the service user 31 are correct.

The service start/end unit 42 has a function for authenticating the service user 31 based on the ID and the password entered by using the user terminal 1 in the train. The service start/end unit 42 also has a function for employing the ID/password information 46 and the operating information 47 to start or halt the provision of a service relative to the train connection device 2 in FIG. 1.

The operating information processor 43 has a function for collecting, from the operating information management system 13, owned by the railroad company, in FIG. 1, information about the operating state, and for recording or updating the operating information 47.

The communication quantity processor 44 has a function for recording, in the communication quantity information 48, the communication quantity, such as the number of packets or the number of bytes, that is obtained from the train connection device 2.

The fee processor 45 has a function for performing a charging process with the service fee collection company 32, the ISP 33, the communication common carrier (A) 34, the communication common carrier (B) 35 and the railroad company 36.

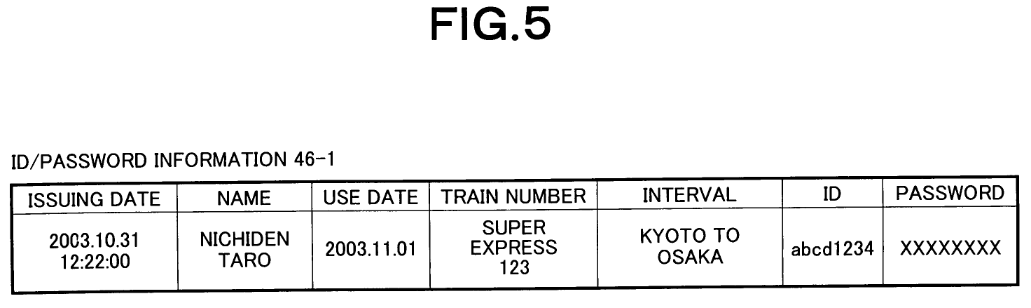

The ID/password information 46 includes the issuing date and time, the name, the train number, the interval, the use date, the ID and the password. A specific example of this information 46 is shown in FIG. 5. FIG. 5 is a diagram showing an example structure for ID/password information 46-1. In FIG. 5, it is recorded that “NICHIDEN TARO” made a service use contract for Special Express 123, between Kyoto and Osaka, on Nov. 1, 2003, and an ID, issued at 12:22 on Oct. 31, 2003 is “abcd1234” and a password issued at the same time and on the same date is “xxxxxxxx”.

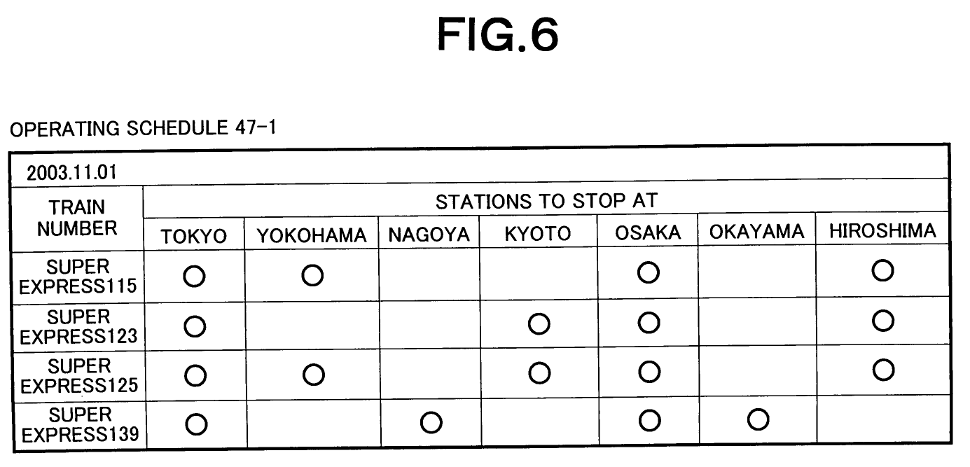

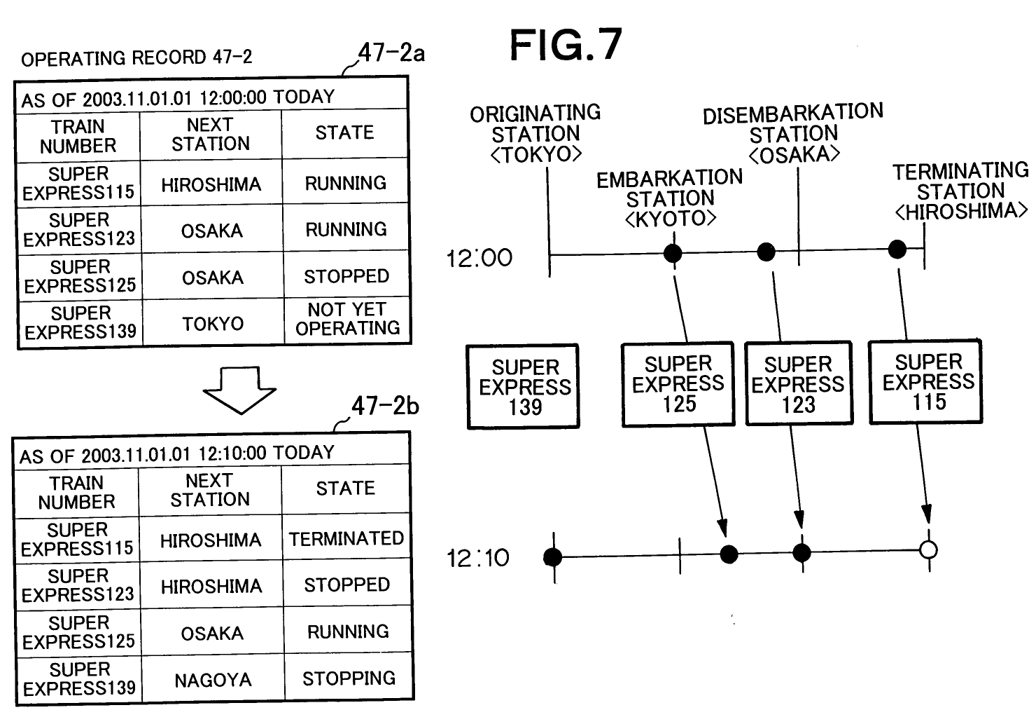

The operating information 47 includes an operating schedule 47-1 and an operating record 47-2. FIG. 6 is a diagram showing an example for the operating schedule 47-1, and FIG. 7 is a diagram showing an example for the operating record 47-2.

In FIG. 6, the operating schedule 47-1 represents an operating schedule for a train that includes a date, a train number and stations at which the train stops (including an originating station and a terminal station). Stations for which circles are entered in the operating schedule 47-1 are the stations at which the train stops.

That is, as an example, the stations at which Special Express 115 stops are Tokyo, Yokohama, Osaka and Hiroshima; the stations at which Special Express 123 stops are Tokyo, Kyoto, Osaka and Hiroshima; the stations at which Special Express 125 stops are Tokyo, Yokohama, Kyoto, Osaka and Hiroshima; and the stations at which Special Express 139 stops are Tokyo, Nagoya, Osaka and Okayama.

Referring to FIG. 7, a operating record 47-2a represents a date, a train number, the next station stop and the operating state (before operating/being halted/during operation/operation completed) of the train, which are obtained from the operating information management system 13 in FIG. 1. An operating record 47-2b represents a record for the ten minute elapsed time shown in the operating record 47-2.

A detailed explanation will be given by using the operating records 47-2a and 2b. According to the operating record 47-2a, it is found that “Special Express 115” is currently traveling toward Hiroshima Station, that is a terminal station, and “Special Express 123” is currently running toward Osaka Station. According to the operating record 47-2b, it is found that “Special Express 115” has arrived at Hiroshima Station and ended operation and that “Special Express 123” is stopped at Osaka Station and the next station at which it will stop is Hiroshima Station.

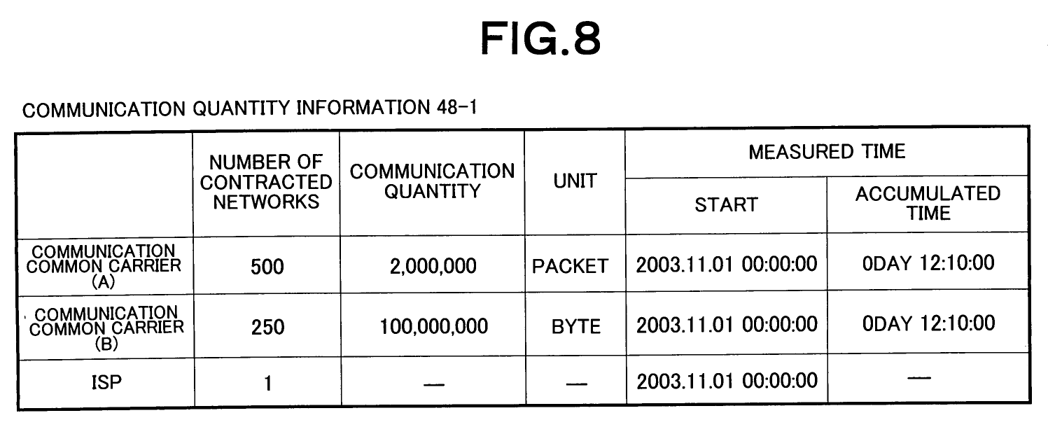

The communication quantity information 48 will be explained while referring to FIG. 8. FIG. 8 is a diagram showing an example configuration for communication quantity information 48-1. The communication quantity information 48 includes, for each of the communication common carriers 34 and 35 (including the ISP 33), the number of contracted networks, the quantity of communication, the unit used for the communication quantity and the period used for measurement (the start time and the accumulated time).

The communication quantity information 48-1 in FIG. 8 indicates that “when 12 hours, 10 minutes and 00 seconds had elapsed since 0:00:00 on Nov. 1, 2003, the number of networks under contract with the communication common carrier (A) 34 was 500, and the communication quantity was 2,000,000 packets”. The number of contracted networks entered here represents the units of the contract concluded with the communication common carrier (A) 34, and the train connection device 2, for example, is defined as one contract.

The communication quantity information 48-1 also indicates that “when 12 hours, 10 minutes and 00 seconds had elapsed since from 0:00:00 on Nov. 11, 2003, the number of networks under contract with the communication common carrier (B) 35 was 250, and the communication quantity was 100,000,000 bytes” and that “the number of networks under the contract concluded with the ISP 33 is one at 0:00:00 on Nov. 1, 2003”.

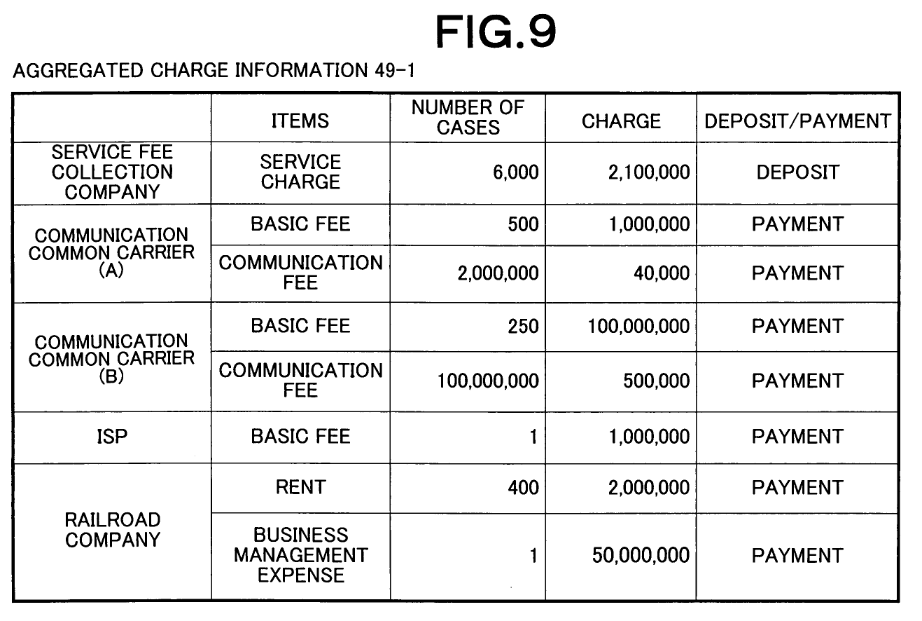

The charging information 49 is information concerning the money transaction that takes place when a network access service is provided. FIG. 9 is a diagram showing an example structure for aggregated charge information 49-1. In FIG. 9, the first row indicates “a payment from the service fee collection company of a total of 2,1000,000 yen for the service use for 6,000 contracts”.

The second row indicates “a payment to the communication common carrier (A) 34 of a total of 1,000,000 yen for the basic fee for 500 cases, and of a total of 40,000 yen for the communication fee for 2,000,000 packets”.

The third row indicates “a payment to the communication common carrier (B) 35 of a total of 100,000,000 yen for the basic fee for 250 cases, and of a total of 500,000 yen for the communication fee for 100,000,000 bytes”.

The fourth row indicates “a payment to the ISP 33 of a total of 1,000,000 yen for the basic fee for one case”.

The fifth row indicates “a payment to the railroad company 36 of a total of 2,000,000 yen for the rent for 400 cases, and of a total of 50,000,000 yen as the business management fee for one case”.

The charging information 49 is updated when the ID/password issuing unit 41 issues an ID and a password, and is also updated by the fee processor 45 based on the operating information 47, the communication quantity information 48 and the fee table information 50.

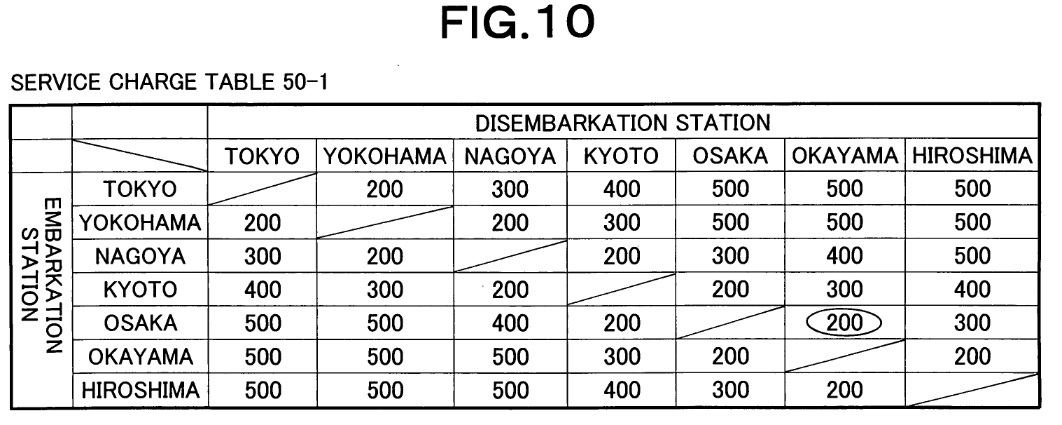

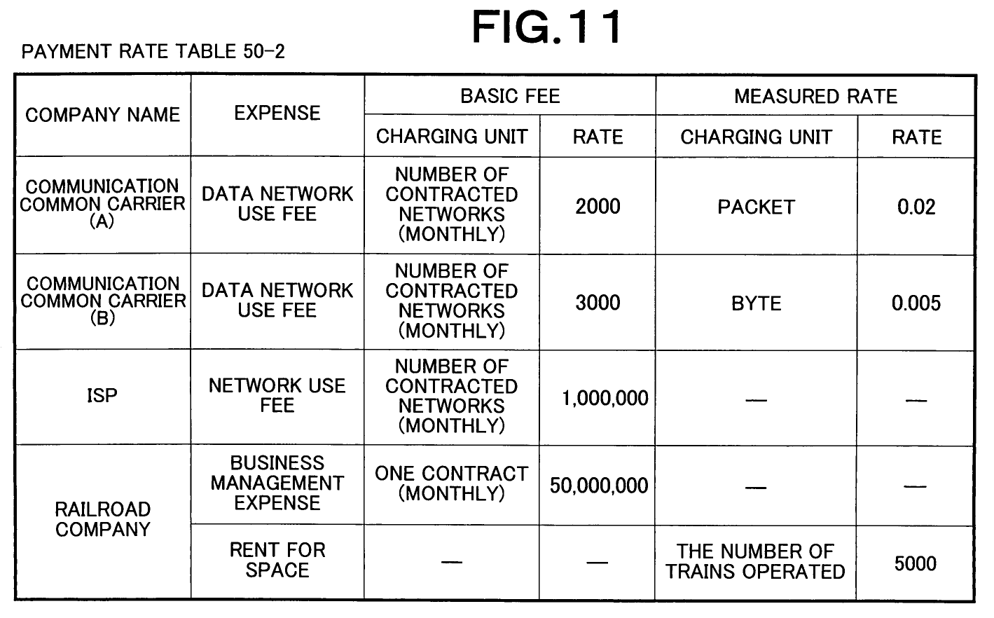

The fee table information 50 includes a service charge table 50-1 and a payment rate table 50-2. FIG. 10 is a diagram showing an example structure for the service charge table 50-1 and FIG. 11 is a diagram showing an example structure for the payment rate table 50-2.

Example service charges for individual onboard intervals are entered in the service charge table 50-1. In FIG. 10, the service charge table 50-1 shows that “a service charge between Kyoto and Osaka is 200 yen”. For the sake of convenience, the charges for the other intervals are simply shown in FIG. 10.

Referring to FIG. 11, the payment rate table 50-2 includes the name of a communication company, the fixed rate (the unit used for charging and the rate) and the measured rate (the unit used for charging and the rate). In the payment rate table 50-2, the charging system for the communication common carrier (A) 34 is recorded as “a fixed rate of 2,000 yen by the month with the number of contracted networks being a unit, and as a measured rate of 0.02 yen for one packet”.

Similarly, the charging system for the communication common carrier (B) 35 is recorded as “a fixed rate of 3,000 yen by the month with the number of contracted networks being a unit, and as a measured rate of 0.005 yen for one byte”; the charging system for the ISP 33 is recorded as “a fixed rate of 1,000,000 yen by the month with the number of contracted networks being a unit”; and the charging system for the railroad company 36 is recorded as “a fixed rate of 50,000,000 yen by the month with one contract being a unit, and as a measured rate of 5,000 yen for one train operation”.

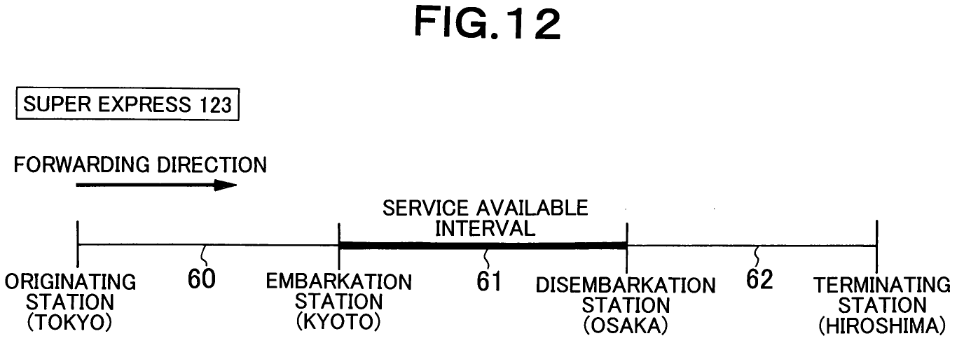

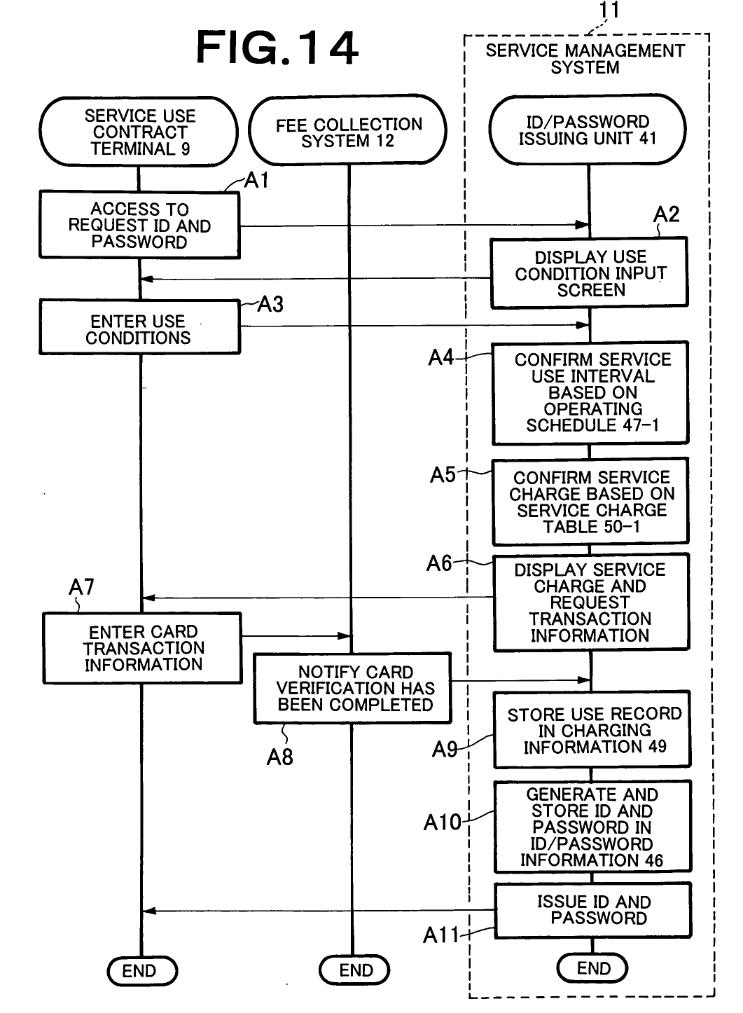

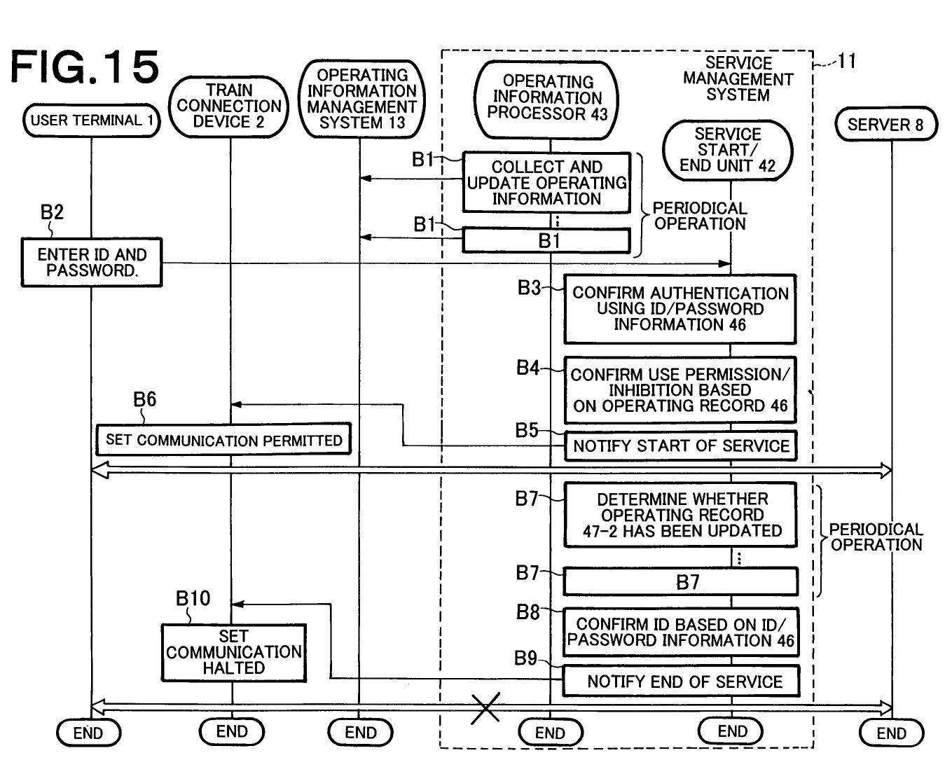

The operation of this embodiment will now be described while referring to FIGS. 12 to 15. FIG. 12 is a diagram for explaining an example onboard interval for a user. FIG. 13 is a diagram showing an example use condition input screen. FIG. 14 is a flowchart showing an example operation performed by the ID/password issuing unit 41 until an ID and a password have been issued. FIG. 15 is a flowchart showing an example operation from the start of a service for a service user until the end of the service.

First, while referring to FIGS. 12 to 15, an explanation will be given for the operation of the service management system 11 from the start of the provision of a train network access service for a service user, a passenger, until the provision of the service is ended.

A detailed explanation will be given by employing a case wherein, as is shown in FIG. 12, a service user boards on “Super Express 123” and utilizes a network access service during an interval between Kyoto station, which is his or her embarkation station, and Osaka station, which is his or her disembarkation station.

It is understood from the operating schedule 47-1 in FIG. 6 that “Super Express 123” originates at Tokyo station, stops at Kyoto and Osaka stations and terminates at Hiroshima station.

The operation of the ID/password issuing unit 47 until an ID and a password have been issued will be described while referring to FIG. 14.

Before or after boarding, a service user employs the service use contract terminal 9 to access the ID/password issuing unit 41 of the service management system 11 (step A1).

Upon receiving an ID/password issuing request, the ID/password issuing unit 41 displays a use condition input screen 70 in FIG. 13 on the service use contract terminal 9 (step A2).

The service user enters use conditions, such as a date, a train number and an onboard interval, by using the service use contract terminal 9, and transmits the entered data to the ID/password issuing unit 41. Referring to the use condition input screen 70 in FIG. 10, the service user has entered as use conditions, “use of the service between Kyoto and Osaka on Super Express 123 on Nov. 1, 2003” (step A3).

Upon receiving the use conditions, the ID/password issuing unit 41 determines whether the use conditions match the contents of the operating schedule 47-1 in FIG. 6. Since it is understood from the operating schedule 47-1 in FIG. 6 that “Super Express 123 on Nov. 1, 2003 stops at Tokyo, Kyoto, Osaka and Hiroshima”, it is ascertained that the service is available under the use conditions entered at step A3 (step A4).

Next, the ID/password issuing unit 41 examines the service charge 50-1 in FIG. 10 to identify the embarkation station and the disembarkation station and obtain the use fee. It is understood from the service charge table 50-1 in FIG. 10 that the service charge between Kyoto station, the embarkation station, and Osaka station, the disembarkation station, is 200 yen” (step A5).

The ID/password issuing unit 41 employs the fee information obtained at step A5 to display, on the service use contract terminal 9, a screen on which the service charge is shown and transaction information, such as credit card information, is requested (see a card information input screen 71 in FIG. 13) (step A6).

The service user employs the service use contract terminal 9 to enter the name of the user, the credit card number and the expiration date, and transmits the data to the fee collection system 12 (step A7).

Referring to the card information input screen 71 in FIG. 13, the service user has entered, as an example, last name: NICHIDEN, first name: TARO, credit card number: 1234567890123456 and expiration date: 03/06.

Upon receiving the transaction information, the fee collection system 12 examines the contents of this information, and notifies the ID/password issuing unit 41 that verification has been completed normally (step A8).

Upon receiving a card verification end notification, the ID/password issuing unit 41 updates the aggregated charge information 49-1 in FIG. 9 (step A9).

Further, the ID/password issuing unit 41 generates a unique ID and a unique password, and adds them to the ID/password information 46-1, together with the contract date and time and the use conditions (step A10).

Finally, the ID/password issuing unit 41 displays the ID/password issuing screen 72 in FIG. 13 on the service use contract terminal 9, and issues the ID and the password (step A11).

Referring to the ID/password issuing screen 72 in FIG. 13, the ID and the password are issued for use only on date: Nov. 1, 2003, on train number: Super Express 123 and for onboard interval: Kyoto to Osaka.

The operation of this embodiment, from the start of the service provision for a service user until the service is ended, will now be described while referring to FIG. 15.

The operating information processor 43 periodically collects, from the operating information management system 13, the operating schedule and the operating record that constitute operating information, and records them in the operating information 47 (step B1).

Before starting communication with the server 8, the service user employs the user terminal 1 to access the service start/end unit 42 of the service management system 11, and transmits his or her ID and password (step B2).

Upon receiving the ID and the password, the service start/end unit 42 examines the ID/password information 46-1, determines whether the received ID and password match the ID and password generated at step A10, and authenticates the service user (step B3).

Then, the service start/end unit 42 examines the operating record 47-2 to confirm that the use conditions, such as the date, the train number and the onboard interval, are correct. Referring to the operating record 47-2a, “at 12:00:00 on Nov. 1, 2003, Super Express 123 is proceeding ahead to Osaka station, which is the next stop”, and during this time, service can be obtained by employing the ID and the password that were issued under the conditions “Nov. 1, 2003, Super Express 123, and between Kyoto and Osaka” (step B4).

After ten minutes have elapsed, “12:10:00 on Nov. 1, 2003, Super Express 123 is currently stopped en route to Hiroshima, which is the next stop, i.e., is currently stopped at Osaka station”, so that service under the above described conditions is no longer available.

When it is ascertained at steps B3 and B4 that the ID, the password and the use conditions are correct, the service start/end unit 42 transmits a service start notification to the train connection device 2 to enable the user terminal 1 to communicate with the server 8 (step B5). Upon receiving the service start notification, the train connection device 2 permits communication between the user terminal 1 and the server 8 (step B6).

The service start/end unit 42 periodically examines the operating information 47, which includes the operating schedule 47-1 and the operating record 47-2 that are updated by the operating information processor 43 (step B7).

When the operating state of the train is changed, the service start/end unit 42 examines the ID and password information 46-1, and identifies the ID for which the service should be ended (step B8).

The service start/end unit 42 transmits a service end notification to the train connection device 2 to halt communication between the server 8 and the user terminal 1 that corresponds to the ID identified at step B8 (step B9).

Upon receiving the service end notification, the train connection device 2 halts communication between the user terminal 1 and the server 8 (step B10).

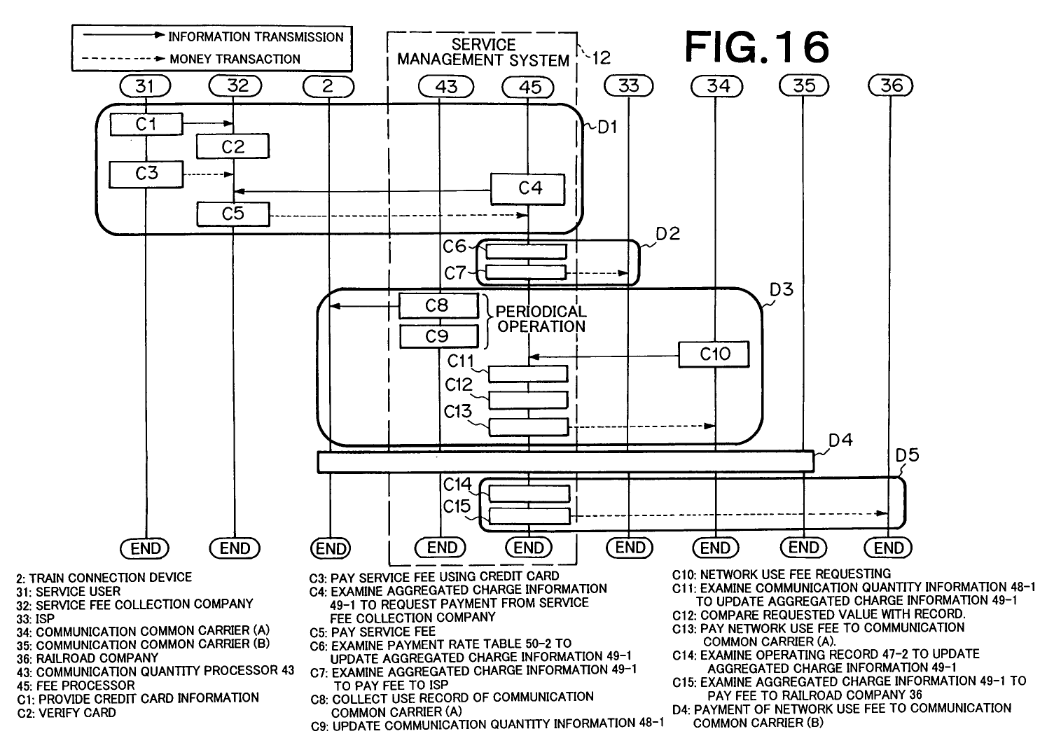

The “money transfer” operation of the embodiment will now be described in detail while referring to FIG. 16. FIG. 16 is a flowchart showing an example “money transfer” operation performed by the embodiment.

In this embodiment, as is shown in FIG. 3, the service management company 30 that owns the service management system 11 transfers money to the service fee collection company 32, the ISP 33, the communication common carrier (A) 34, the communication common carrier (B) 35 and the railroad company 36.

In FIG. 16, in processing D1 for the transaction of a service charge, first, the service user 31 provides credit card information for the service fee collection company 32 (step C1).

The service fee collection company 32 then verifies the received card information (step C2).

When the verification of the card information has been completed, the service user 31 pays the service charge by using his or her credit card (step C3).

The processes at steps C1 to C3 are performed for each service user (steps A6 and A7 in FIG. 7). An explanation will now be given for the processing performed when the service management company collects a service charge. A payment is requested of the service fee collection company 32 based on the aggregated charge information 49-1 recorded at step A8 in FIG. 14 (step C4).

The service fee collection company 32 pays the requested money value to the fee processor 45 of the service management system 11 owned by the service management company 30 (step C5).

An explanation will be given for processing D2 performed by the service management company 30 when paying a network use fee to the ISP 33. The fee processor 45 examines the payment rate table 50-2 to update the aggregated charge information 49-1 relative to the ISP 33 (step C6).

Then, the fee processor 45 pays the network use fee to the ISP 33 based on the aggregated charge information 49-1 (step C7).

An explanation will now be given for the processing (D3 in FIG. 16) for paying a fee for the use of a service provided through the data communication network (A) 3 in FIG. 1. The service management system 11 employs the communication quantity processor 44 to periodically collect the record, held by the train connection device 2, for the use (data quantity) of the data communication network (A) 3 (step C8).

The communication quantity information 48-1 is updated by using the collection use record (step C9).

The communication common carrier (A) 34 requests the network use fee of the service management company 30 in accordance with the data quantity (the use record) measured by the communication common carrier (A) 34 (step C10).

Upon receiving this request, the service management company 30 employs the fee processor 45 of the service management system 11 to update the aggregated charge information 49-1 based on the communication quantity information 48-1 and the payment rate table 50-2 (step C11).

The fee processor 45 compares the use record indicated by the aggregated charge information 49-1 with the money value requested at step C9 (step C12). When the normal money value is requested, the network use fee is paid to the communication common carrier (A) 34 (step C13).

The same processing (D3 (steps C8 to C13) in FIG. 16) as performed by the fee processor 45 for the communication common carrier (A) 34 is performed for the payment to the communication common carrier (B) 35 (D4 in FIG. 16).

The payment means of the service management company 30 relative to the railroad company 36 will now be described (D5 in FIG. 16). Since the fee that is charged depends on the operating record for the train, e.g., the rent for the space on the train is changed depending on the number of trains operating and the operating periods, the fee to be paid by the service management company 30 to the railroad company 36 is calculated based on the operating record 47-2 and the payment rate table 50-2, and the aggregated charge information 49-1 is updated (step C14).

The service management company 30 employs the fee processor 45 to examine the aggregated charge information 49-1 and pay the money value to the railroad company 36 (step C15).

As is described above, according to the first embodiment of the invention, it is easy to transfer money using a troublesome credit card relative to the individual service users and multiple communication common carriers, and to collect money that is owed by issuing an ID and a password. Further, a network access service available only for a limited distance and a limited time, such as on a train, can be provided.

The configuration for a second embodiment of the present invention will now be described in detail. According to the first embodiment, the service use contract terminal 9 in FIG. 1 is an information terminal, such as a user owned cellular phone, so that is used to establish a contract that permits the user to receive a network access service on a train. However, a fixed terminal installed at a station by a service management company or a railway company may be employed as a service use contract terminal. In this case, for the collection of a service fee, the service fee collection company 32 performs a transaction using a credit card, as in the first embodiment.

The service management system 11 and the operating information management system 13 may be integrally formed. That is, the railroad company 36 may comprise both the service management system 11 and the operating information management system 13. Likewise, the communication common carrier (A) 34 or (B) 35, or the ISP 33, and the service management system 11 may be integrally formed.

In addition, the user terminal 1 and the service use contract terminal 9 may be integrally formed. In this case, for example, even before an ID and a password have been issued, the user terminal 1 can employ a specific method (e.g., the designation of a predetermined URL (Uniform Resource Locator) on a Web browser) to specially communicate with the ID/password issuing unit 41 of the service management system 11 and the fee collection system 12 via the train connection device 2.

As is described above, according to the second embodiment of the invention, since the fixed terminal is employed as the service use contract terminal 9, a service user can make a service use contract outside the train, and even when not holding a cellular phone.

Furthermore, since the service management system 11 and the operating information management system 13 are integrally formed, the railroad company 36 can collect a service fee. Further, since the communication common carrier (A) 34 or (B) 35, or the ISP 33, and the service management system 11 are integrally formed, the communication common carrier (A) 34 or (B) 35 or the ISP 33 can collect a service fee.

In addition, since the user terminal 1 and the service use contract terminal 9 are integrally formed, the service user needs only one terminal to both make a contract for a service and to receive a service.

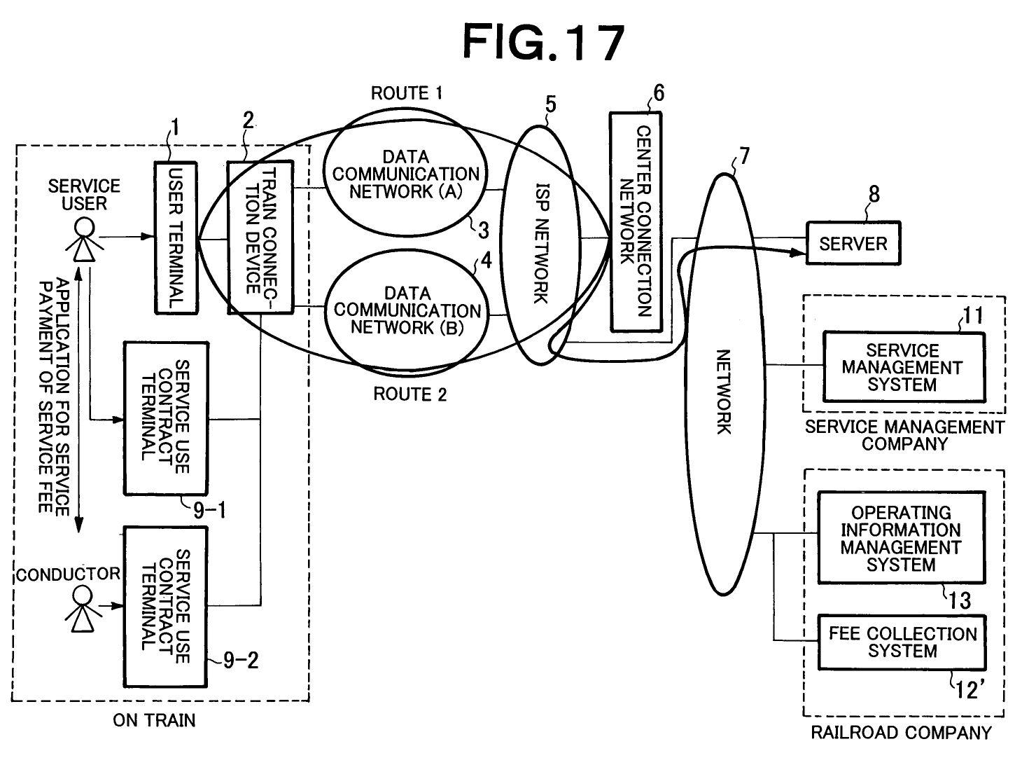

A third embodiment of the present invention will now be described. FIG. 17 is a diagram showing the configuration of a communication system according to the third embodiment of the invention.

In FIG. 17, a service use contract terminal 9-1 is installed on a train, and is connected to a train connection device 2, so that a service user can receive a service without making a contract before boarding.

The service use contract terminal 9-1 not only has a function for performing a transaction using a credit card, but also has a function for performing a transaction using cash, just as in vending machines and ticket issuing machines. A service use contract terminal 9-2 carried by a conductor has a function for performing a transaction using cash on a train in the same manner a fare is adjusted, and a function for communicating with an ID/password issuing unit 41 of a service management system 11 to issue an ID and a password.

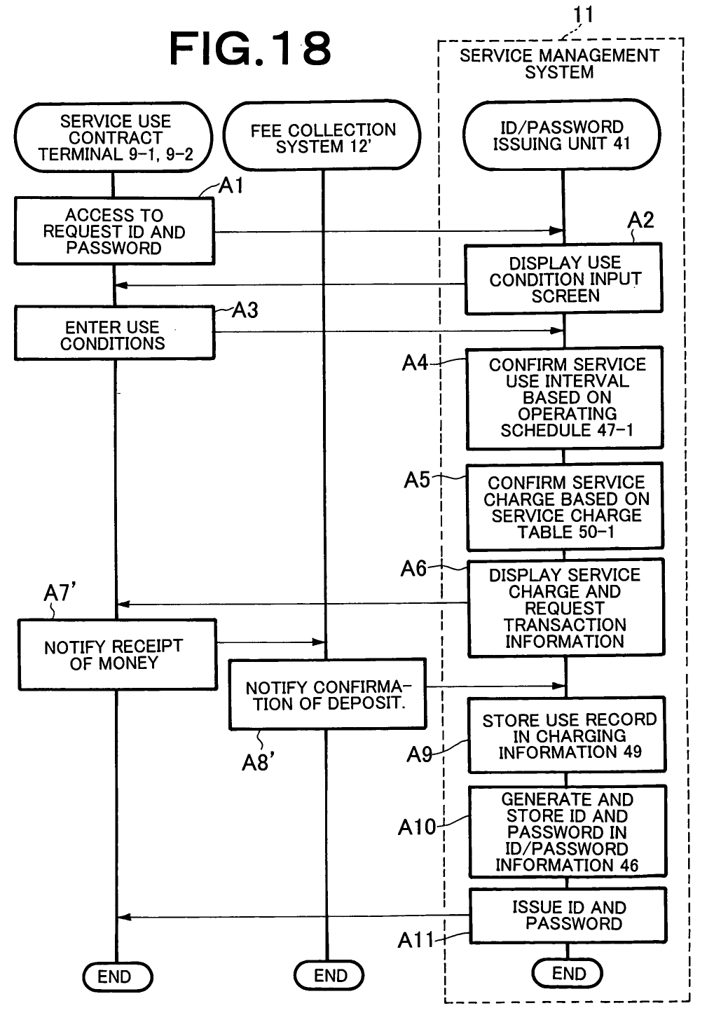

A fee collection system 12′ has a cash transaction function, in addition to the functions of the fee collection system 12 owned by the service fee collection company 32 in the first embodiment. The service fee collection company 32 in the first embodiment may be the railroad company 36, and in the configuration in FIG. 17, the railroad company 36 owns the fee collection system 12′ and serves as a service fee collection company. While referring to FIG. 18, an explanation will now be given for a “transfer of money” when a transaction using cash is performed by the service use contract terminals 9-1 and 9-2. FIG. 18 is a flowchart showing an example operation according to this embodiment performed by the ID/password issuing unit 41 until an ID and a password have been issued.

For a transaction using cash, at step A6 in FIG. 14, the card transaction information is entered; however, in this embodiment, as is shown at step A7′ in FIG. 18, cash is received by the terminal or the conductor, and the service use contract terminal 9-1 or 9-2 notifies the fee collection system 12 that the money has been received (step A7′).

Upon receiving this notification, the fee collection system 12′ transmits a credit confirmation notification to the ID/password issuing unit 41 to request the issuing of an ID and a password, as in the first embodiment (step A8′).

As is described above, according to the third embodiment, a transaction using cash is enabled.

In the above embodiments, the two data communication networks (A) and (B) have been employed (see FIGS. 1 and 17). However, the present invention is not limited to two, and can also be applied for three or more data communication networks.

According to the present invention, the present invention can be employed not only for the train network access service management system, but also for a case wherein a seamless connection or a multiplex connection of radio access networks is established on vehicles, such as buses (e.g., long-distance buses) and ships, to provide a stable Internet access service. The present invention can also be applied for a case wherein a network access service is provided by both radio and wire, such as ADSL (Asymmetric Subscriber Line) or light, within a temporary and limited area such as an event hall, a factory site or a disaster area.

1. A train network access service management method, for managing multiple network access services on a train, comprising the step of:
multiple communication common carriers that own different data communication networks, a network access service provider that connects the different data communication networks to other networks, a railroad company that owns the train, or another company collecting service charges from service users collectively through the other networks.

2. The train network access service management method according to claim 1, whereby the step of collecting service charges includes the steps of:
issuing an ID and a password effective for a date, for a train and for an interval designated by each service user;
authenticating the ID and the password, and starting the provision of service for the service user, which is a passenger; and
halting the service when the ID and the password have expired.

3. The train network access service management method according to claim 1, whereby the step of collecting service charges includes the step of:
collecting an operating schedule and a current operating state from an operating information management system owned by the railroad company in order to ascertain the operating condition of the train.

4. The train network access service management method according to claim 1, whereby a train connection device for connecting a user terminal to the data communication networks is provided on the train; and whereby the step of collecting service charges includes the step of:
collecting, from the train connection device, network use records for the communication common carriers and the network access service provider before the provision of a service for the passenger is started.

5. The network access service management method according to claim 1, whereby the step of collecting service charges includes the step of:
paying a fee based on a network use record for the service user to the communication common carriers, the network access service provider and the railroad company.

6. The train network access service management method according to claim 1, further comprising the step of
permitting the service user to enter transaction information for a service charge to a fee collection system; and whereby the step of collecting service charges includes the step of requesting the fee collection system to collect the service charge that is indicated in the transaction information, and of receiving the service charge.

7. The train network access service management method according to claim 1, whereby the step of collecting the service charges includes the step of:
permitting the service user to perform a transaction using a credit card.

8. The train network access service management method according to claim 1, whereby the step of collecting the service charges includes the step of:
permitting the service user to perform a transaction using cash.

9. The train network access service management method according to claim 1, whereby the service user employs a service use contract terminal and a data communication network, other than the multiple data communication networks, to issue a request for the ID and the password, and performs a transaction for a service charge.

10. The train network access service management method according to claim 1, whereby the service user employs a service use contract terminal and the data communication networks to issue a request for the ID and the password, and to perform a transaction for a service charge.

11. The train network access service management method according to claim 1, whereby the multiple data communication networks are seamlessly connected during an operating interval for a train used by the service user.

12. The train network access service management method according to claim 11, whereby the multiple data communication networks are multiplexed at connection points.

13. A communication system for managing multiple network access services on a train comprising:
a unit for permitting multiple communication common carriers that own different data communication networks, a network access service provider that connects the different data communication networks to other networks, a railroad company that owns the train, or another company, to collect service charges from service users collectively through the other networks.

14. The communication system according to claim 13, wherein the unit for collecting service charges includes:
a unit for issuing an ID and a password effective for a date, for a train and for an interval designated by each service user;
a unit for authenticating the ID and the password, and starting the provision of service for the service user, which is a passenger; and
a unit for halting the service when the ID and the password have expired.

15. The communication system according to claim 13, wherein the unit for collecting service charges includes:
a unit for collecting an operating schedule and a current operating state from an operating information management system owned by the railroad company in order to ascertain the operating condition of the train.

16. The communication system according to claim 13, wherein a train connection device for connecting a user terminal to the data communication networks is provided on the train; and wherein the unit for collecting service charges includes:
a unit for collecting, from the train connection device, network use records for the communication common carriers and the network access service provider before the provision of a service for the passenger is started.

17. The communication system according to claim 13, wherein the unit for collecting service charges includes:
a unit for paying a fee based on a network use record for the service user to the communication common carriers, the network access service provider and the railroad company.

18. The communication system according to claim 13, further comprising
a unit for permitting the service user to enter transaction information for a service charge to a fee collection system; and wherein the unit for collecting service charges includes a unit for requesting the fee collection system to collect the service charge that is indicated in the transaction information, and for receiving the service charge.

19. The communication system according to claim 13, wherein the unit for collecting the service charges includes:
a unit for permitting the service user to perform a transaction using a credit card.

20. The communication system according to claim 13, wherein the unit for collecting the service charges includes:
a unit for permitting the service user to perform a transaction using cash.

21. The communication system according to claim 13, wherein the service user employs a service use contract terminal and a data communication network, other than the multiple data communication networks, to issue a request for the ID and the password, and performs a transaction for a service charge.

22. The communication system according to claim 13, wherein the service user employs a service use contract terminal and the data communication networks to issue a request for the ID and the password, and to perform a transaction for a service charge.

23. The communication system according to claim 13, wherein the multiple data communication networks are seamlessly connected during an operating interval for a train used by the service user.

24. The communication system according to claim 23, wherein the multiple data communication networks are multiplexed at connection points.

25. A service management system for managing multiple network access services on a train comprising:
a unit to serve as a proxy for multiple communication common carriers, which own different data communication networks, a network access service provider, which connects the different data communication networks to other networks, a railroad company, which owns the train, or another company to collect service charges from service users collectively through the other networks.

26. The service management system according to claim 25, wherein the unit for collecting service charges includes:
a unit for issuing an ID and a password effective for a date, for a train and for an interval designated by each service user;
a unit for authenticating the ID and the password, and starting the provision of service for the service user, which is a passenger; and
a unit for halting the service when the ID and the password have expired.

27. The service management system according to claim 25, wherein the unit for collecting service charges includes:
a unit for collecting an operating schedule and a current operating state from an operating information management system owned by the railroad company in order to ascertain the operating condition of the train.

28. The service management system according to claim 25, wherein a train connection device for connecting a user terminal to the data communication networks is provided on the train; and wherein the unit for collecting service charges includes:
a unit for collecting, from the train connection device, network use records (communication quantities) for the communication common carriers and the network access service provider before the provision of a service for the passenger is started.

29. The service management system according to claim 25, wherein the unit for collecting service charges includes:
a unit for paying a fee based on a network use record for the service user to the communication common carriers, the network access service provider and the railroad company.

30. The service management system according to claim 25, further comprising
a unit for permitting the service user to enter transaction information for a service charge to a fee collection system; and wherein the unit for collecting service charges includes a unit for requesting that the fee collection system collect the service charge that is indicated in the transaction information, and for receiving the service charge.

31. The service management system according to claim 25, wherein the unit for collecting the service charges includes:
a unit for permitting the service user to perform a transaction using a credit card.

32. The service management system according to claim 25, wherein the unit for collecting the service charges includes:
a unit for permitting the service user to perform a transaction using cash.

33. The service management system according to claim 25, wherein the service user employs a service use contract terminal and a data communication network, other than the multiple data communication networks, to issue a request for the ID and the password, and performs a transaction for a service charge.

34. The service management system according to claim 25, wherein the service user employs a service use contract terminal and the data communication networks to issue a request for the ID and the password, and to perform a transaction for a service charge.

35. The service management system according to claim 25, wherein the multiple data communication networks are seamlessly connected during an operating interval for a train used by the service user.

36. The service management system according to claim 35, wherein the multiple data communication networks are multiplexed at connection points.
